(19) United States
(12) Patent Application Publication
(10) Pub. No.: US 2025/0085605 A1
(43) Pub. Date: Mar. 13, 2025

(54) APPARATUSES AND SYSTEMS FOR PANCHARATNAM-BERRY PHASE AUGMENTED GRADIENT-INDEX LIQUID CRYSTAL LENSES

(71) Applicant: Meta Platforms Technologies, LLC, Menlo Park, CA (US)

(72) Inventors: Eugene Cho, Seattle, WA (US); Afsoon Jamali, Issaquah, WA (US)

(21) Appl. No.: 18/828,459

(22) Filed: Sep. 9, 2024

Related U.S. Application Data
(60) Provisional application No. 63/582,306, filed on Sep. 13, 2023.

(51) Int. Cl. G02F 1/29

(52) U.S. Cl. CPC G02F 1/294

(57) ABSTRACT

The disclosed apparatus may include a varifocal lens, where the transmissivity of the varifocal lens changes in relation to the optical power of the varifocal lens; and a transmissivity compensation component that is configured to change as the optical power of the varifocal lens changes, such that a variation of transmissivity of the varifocal lens is less than a variation of transmissivity of the varifocal lens in combination with the transmissivity compensation component. Various other apparatuses, systems, and methods are also disclosed.

### CROSS-REFERENCE TO RELATED APPLICATION

This application claims the benefit of priority under 35 U.S.C. § 119(e) of U.S. Provisional Application No. 63/582,306, filed Sep. 13, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, the drawings demonstrate and explain various principles of the present disclosure.

FIG. 1 illustrates an example apparatus for Pancharatnam-Berry phase augmented gradient-index liquid crystal lenses according to some embodiments.

FIG. 2 illustrates an example system for Pancharatnam-Berry phase augmented gradient-index liquid crystal lenses according to some embodiments.

FIG. 3 illustrates another example system for Pancharatnam-Berry phase augmented gradient-index liquid crystal lenses according to some embodiments.

FIGS. 4A and 4B illustrate a pair of optical elements transitioning with complementary transmissivity.

FIGS. 5A and 5B illustrate a pair of optical elements transitioning with complementary non-uniform transmissivity.

FIG. 6 illustrates a method of manufacture for Pancharatnam-Berry phase augmented gradient-index liquid crystal lenses.

FIG. 7 is an illustration of exemplary augmented-reality glasses that may be used in connection with embodiments of this disclosure.

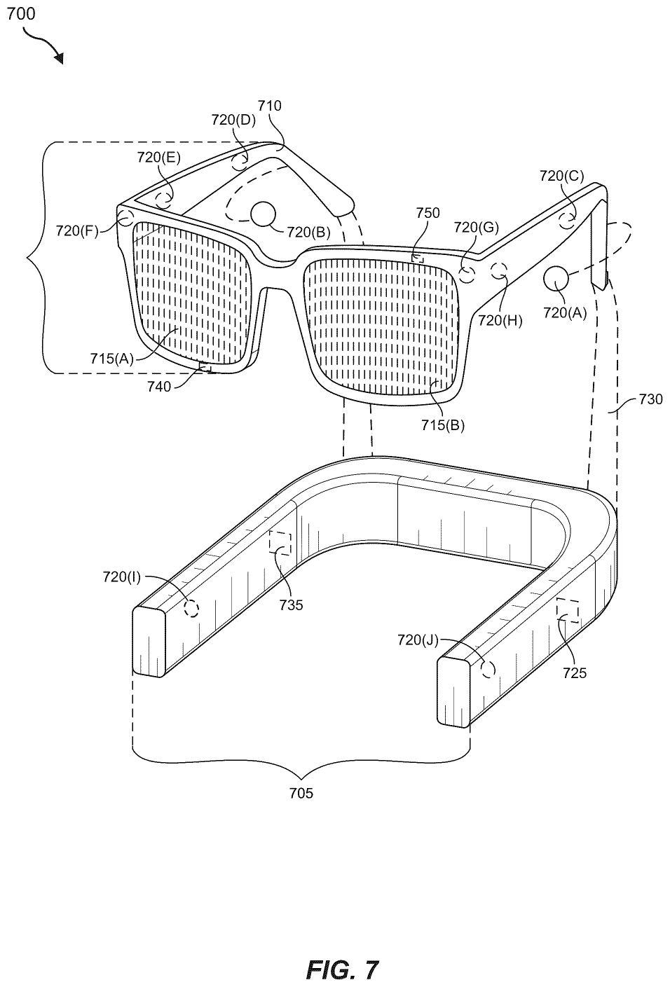

FIG. 8 is an illustration of an exemplary virtual-reality headset that may be used in connection with embodiments of this disclosure.

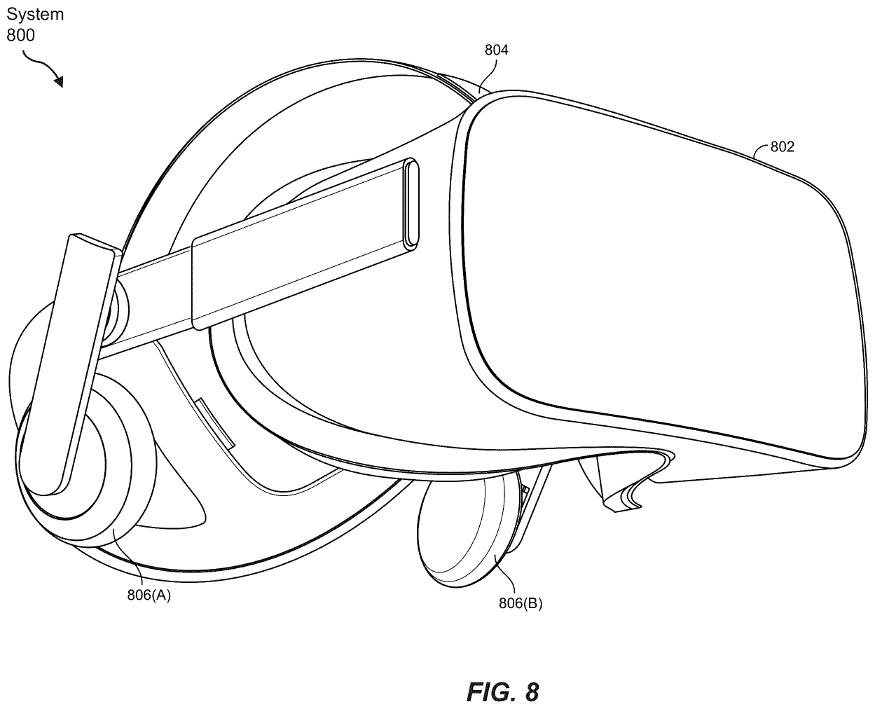

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The present disclosure is generally directed to apparatuses and systems in which Pancharatnam-Berry phase (“PBP”) components augment gradient-index liquid crystal (“GRIN LC”) lenses. GRIN LC lens designs can allow for dynamically adjustable optical power. However, in these designs, transmittance may vary with optical power. However, for many user experiences it may be important to keep varifocal power independent from brightness. Accordingly, a lens stack design may include a GRIN LC lens and a dimming element. The dimming element may vary in transmittance as the GRIN LC lens varies in optical power, such that the lens stack maintains a constant overall transmittance. The dimming element may be a Pancharatnam-Berry Phase (PBP) lens. In some examples, a larger augmented-reality lens assembly may include the GRIN LC/PBP lens on the world side of a display (e.g., a waveguide), with an accommodative lens on the eye side of the display. The GRIN LC/PBP lens, with lower transmittance, may thereby help to reduce the brightness of the world without negatively impacting the brightness of the AR display, and so improve the function of an AR device outdoors, where the environment may ordinarily be too bright relative to the brightness of the display. The use of the accommodative lens on the eye side of the display along with the GRIN LC/PBP lens on the world side of the display may also mitigate and/or eliminate vergence-accommodation conflict. In addition, because the GRIN LC lens may be placed on the world side of the display, an augmented reality image from the display may not be affected by off-axis aberrations.

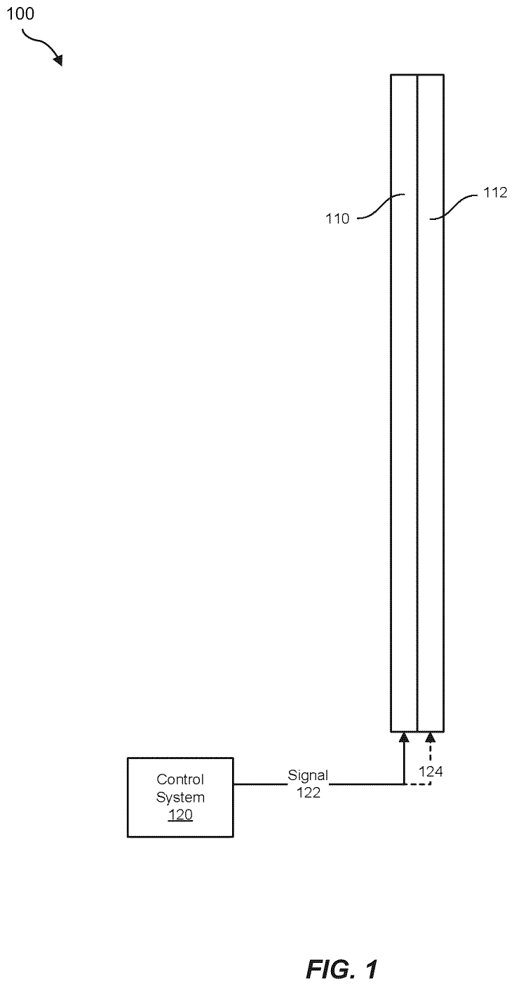

FIG. 1 illustrates an example apparatus 100 for Pancharatnam-Berry phase augmented gradient-index liquid crystal lenses according to some embodiments.

As shown in FIG. 1, apparatus 100 may include a GRIN LC module 110 and a PBP module 112. In addition, in some examples apparatus 100 may include a control system 120 that transmits one or more signals 122 and/or 124 to GRIN LC module 110 and/or PBP module 112.

Across various optical engineering applications including eyeglasses, contact lenses, and optical elements in augmented reality (AR) and virtual reality (VR) systems, liquid crystal (LC) lenses may provide a number of advantages due to their electrically tunable focusing capability, where the associated optical mechanism is based on a spatially localized modulation of light speed resulting from LC molecular orientations driven by applied electric fields.

In such context the realization of a continuous distribution of phase retardation across larger aperture (>10 mm) LC lenses may be challenged by the limited birefringence (<0.8) of LC materials as well as their mechanically compliant nature. In some embodiments, a gradient-index configuration may be used to provide tunability of focus quality.

Gradient-index (GRIN) optics refers to a branch of optics where optical effects are produced by a spatial gradient in the refractive index of a material. A gradual refractive index variation may be used to manufacture lenses having planar surfaces, for example, or to reduce aberrations in imaging applications. In an LC lens having an axial gradient configuration, the refractive index may vary along the optical axis of an inhomogeneous medium such that surfaces of constant index are planes that are oriented perpendicular to the optical axis. In a radial/cylindrical refractive index gradient configuration, on the other hand, the index profile may vary continuously from a centerline of the optical axis to the periphery along the transverse direction in such a way that surfaces of constant index are concentric cylinders located about the optical axis. Hybrid GRIN LC lenses having both an axial and a radial/cylindrical refractive index gradient configuration are also contemplated.

GRIN-type LC lenses may be configured to exhibit a gradient distribution of refractive index in response to a spatially inhomogeneous electric field that is applied across the LC layer(s). As such, the lens power of a GRIN LC lens may also be continuously tunable. In some instantiations, there may be a continuous variation of the refractive index within the lens material. An LC lens may be configured in both planar and non-planar (e.g., concave or convex) geometries.

In some examples, adjusting the optical power of a GRIN LC lens may impact the transmissivity of the GRIN LC lens. Thus, for example, adjusting the optical power of the GRIN LC lens may impact the overall transmissivity of the GRIN LC lens. Additionally or alternatively, adjusting the optical power of the GRIN LC lens may impact the transmissivity of the GRIN LC lens non-uniformly over the area of the GRIN LC lens. For example, adjusting the optical power may impact the transmissivity of the GRIN LC lens in radial pattern (e.g., the impact on transmissivity varying in correlation with distance from the center of the GRIN LC lens).

In view of the foregoing, when control system 120 transmits a signal 122 to GRIN LC lens 110 that alters the optical power of GRIN LC lens 110 (and, thus, the transmissivity of GRIN LC lens 110), a signal may simultaneously alter the transmissivity of PBP module 112. In one example, signal 122 may also be transmitted to PBP module 112, and PBP module 112 may be configured to produce a transmissivity pattern that complements the transmissivity pattern induced by signal 122 in GRIN LC lens 110 to result in a uniform, constant, and/or predetermined transmissivity in (and, e.g., across) apparatus 100. Thus, for example, apparatus 100 may be configured to a predetermined transmissivity of 70%, and PBP module 112 may alter its transmissivity to complement the transmissivity of GRIN LC lens 110 such that the overall transmissivity and/or the location-specific transmissivity of each part of apparatus 100 reaches 70%. In some examples, PBP module 112 may not exactly complement the transmissivity of GRIN LC lens 110, but may instead approximate complementing the transmissivity of GRIN LC lens 110, such that, e.g., the overall transmissivity and/or the location-specific transmissivity of apparatus 100 is more uniform and/or consistent than the transmissivity of GRIN LC lens 110 alone.

In various examples, the overall transmissivity of apparatus 100 may vary by no more than 1% of a predetermined overall transmissivity, by no more than 2%, by no more than 5%, and/or by no more than 10%. In various examples, the overall transmissivity of apparatus 100 may vary by less than 50% the amount that the transmissivity of GRIN LC lens 110 alone varies, by less than 25%, by less than 10%, and/or by less than 5%. In some examples, at least 80% of the area of apparatus 100 may exhibit less variance in transmissivity than the variance in transmissivity in GRIN LC lens 110, at least 90%, at least 95%, and/or at least 98%. As may be appreciated, in some examples, PBP element 112 may have a uniform transmissivity across its area that changes according to the overall transmissivity of GRIN LC lens 110. In other examples, PBP element 112 may have a non-uniform transmissivity across its area that changes according to the overall transmissivity of GRIN LC lens 110. In some examples, the uniformity of the non-uniform transmissivity of PBP element 112 may change. In other examples, the degree of non-uniformity of the transmissivity of PBP element 112 may stay constant as the overall transmissivity of PBP element 112 changes.

As noted above, in some examples signal 122 may be transmitted to both GRIN LC lens 110 and PBP element 112. In other examples, signal 122 may be modified before reaching PBP element 112 (e.g., resulting in a signal 124 that reaches PBP element 112). However, signal 124 may be based on signal 122, such that PBP element 112 is responsive to the changes induced in GRIN LC lens 110. In some examples, control system 120 may send separate signals 122 and 124 to GRIN LC lens 110 and PBP element 112, respectively (such that, e.g., signals 122 and 124 result in a reduction in variation of overall transmissivity and/or local transmissivity for apparatus 100 relative to that of GRIN LC lens 110 alone).

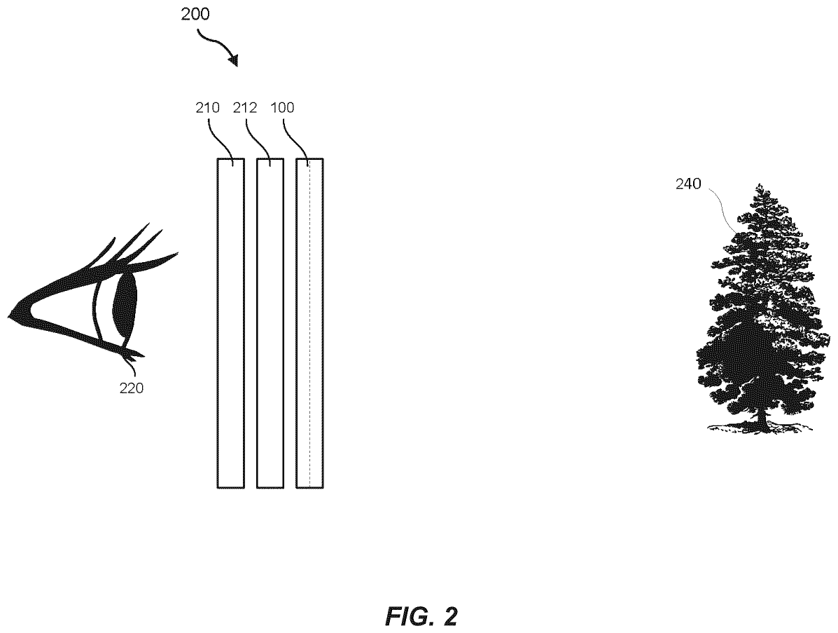

FIG. 2 illustrates an example system 200 for Pancharatnam-Berry phase augmented gradient-index liquid crystal lenses according to some embodiments.

As shown in FIG. 2, system 200 may include an optical stack 210, a display 212, and apparatus 100 from FIG. 1. Optical stack may be placed on the eye side of display 212, and apparatus 100 may be placed on the world side of display 212. In one example, display 212 may be a virtual image display. In some examples, display 212 may include a waveguide.

Optical stack 210 may include any suitable elements. In some examples, optical stack 210 may include an accommodation module. The accommodation module may include any suitable optical element with varifocal capabilities. In some examples, the accommodation module may be planar. For example, the accommodation module may be a planar lens, such as a liquid crystal lens. In some examples, the accommodation module may include a liquid lens (e.g., whose shape is changed by one or more actuators). Additionally or alternatively, in some examples optical stack 210 may include an eye tracking module. In some examples, the eye tracking module may be planar. In various examples, the eye tracking module may include one or more waveguides, one or more photodiodes, one or more photonic integrated circuits, one or more illumination elements, and/or one or more cameras. In some examples, the eye tracking module may track a user's gaze and determine, based on the user's gaze, a focal distance of the user's gaze. In some examples, the focal distance determined at least in part by the eye tracking module may drive the accommodation module (and, e.g., apparatus 100). For example, one or more of the systems described herein may modify the optical power of the accommodation module to eliminate the vergence-accommodation conflict as the user views a virtual image shown from display 212. The GRIN LC lens component of apparatus 100 may then compensate for the change in power of the accommodation module such that the image of the world (including, e.g., an image of an object 240) is not effectively altered at eyebox 220 by the accommodation module. However, because the GRIN LC lens component of apparatus 100 may alter the transmissivity of apparatus 100, the PBP element of apparatus 100 may compensate by altering its own transmissivity, to keep the overall transmissivity (and/or the distribution of transmissivity) of apparatus 100 constant (or, e.g., more constant than that of the GRIN LC lens alone).

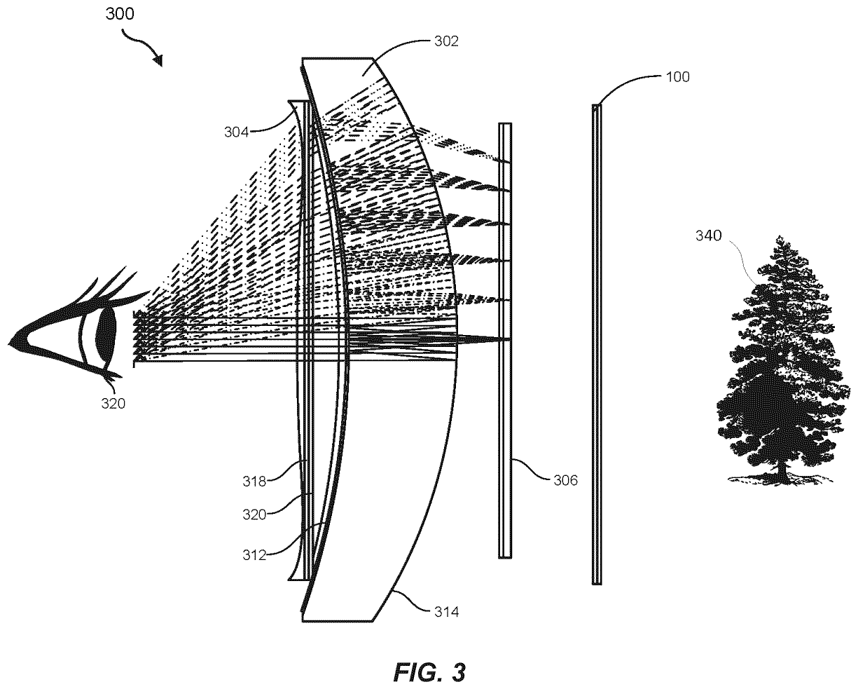

FIG. 3 illustrates an example system 300 for Pancharatnam-Berry phase augmented gradient-index liquid crystal lenses according to some embodiments.

As shown in FIG. 3, system 300 may include illustrates example pancake lens 300 with an embedded accommodation module and an embedded eye tracking module. As shown in FIG. 3, a pancake lens may include a lens 302 and a lens 304. The pancake lens may also include a beamsplitter 314 and a reflective polarizer 312. Additionally, the pancake lens may include an accommodation module 318.

In addition, the pancake lens may include an eye tracking module 320. In some examples, eye tracking module 320 may be planar. In various examples, eye tracking module 320 may include one or more waveguides, one or more photodiodes, one or more photonic integrated circuits, one or more illumination elements, and/or one or more cameras.

As illustrated in FIG. 3, in some embodiments eye tracking module 320 may be embedded into lens 304. For example, lens 304 may be divided into two parts and eye tracking module 320 may be positioned between the two parts of lens 304. In one example, eye tracking module 320 may be positioned adjacent to an accommodation module 318, also embedded into lens 304. Eye tracking module 320 may be embedded within lens 304 in any suitable manner. For example, eye tracking module 320 may be laminated to and/or bonded with accommodation module 318, forming a compound module. The compound module containing may be laminated to and/or bonded with parts of lens 304. In some examples, eye tracking module 320 may be connected to a driving circuit (e.g., using flexible cables or other means) that controls and/or actuates the eye tracking capabilities of eye tracking module 320.

Thus, display 306 may emit an image that reaches eyebox 320, and accommodation module 318 may correct the vergence-accommodation conflict for images produced by display 306 as viewed by a user. In addition, apparatus 100 may compensate for changes in optical power of accommodation module 318 such that, e.g., the image of an object 340 in the world is not modified or distorted. Furthermore, the transmissivity of apparatus 100 may be approximately uniform across its surface and approximately constant over time, even though the transmissivity of the GRIN LC lens component of apparatus 100 may be non-uniform across its surface and/or may change over time.

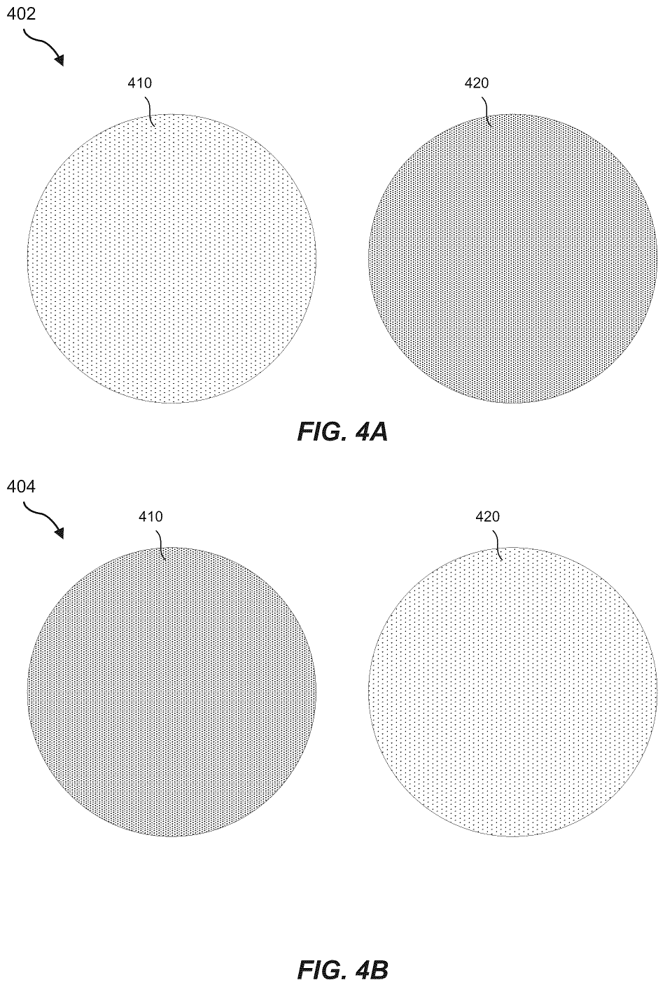

FIGS. 4A and 4B illustrate a pair of optical elements transitioning with complementary transmissivity. As shown in FIG. 4A, in a state 402, a varifocal lens 410 may have a relatively high degree of transmissivity. In response, apparatuses and systems described herein may regulate a transmissivity of a component 420 (such as, e.g., a PBP lens) to complement the transmissivity of varifocal lens 410 (e.g., by providing a lower degree of transmissivity). In one example, control circuitry that regulates the optical power (and, therefore, indirectly regulates the transmissivity) of varifocal lens 410 may transmit a control signal to component 420 to regulate the transmissivity of component 420 to be complementary to that of varifocal lens 410 such that varifocal lens 410 and component 420 in tandem provide a predetermined combined target level of transmissivity.

As shown in FIG. 4B, in a state 404, an optical power of varifocal lens 410 may have changed, thereby impact the transmissivity of varifocal lens 410. For example, the transmissivity of varifocal lens 410 may have decreased. In response, apparatuses and systems described herein may regulate a transmissivity of component 420 to complement the transmissivity of varifocal lens 410 (e.g., by providing a higher degree of transmissivity). In one example, control circuitry that regulates the optical power of varifocal lens 410 may transmit a control signal to component 420 to regulate the transmissivity of component 420 to be complementary to that of varifocal lens 410 such that varifocal lens 410 and component 420 in tandem provide the same predetermined combined target level of transmissivity as was achieved in state 402.

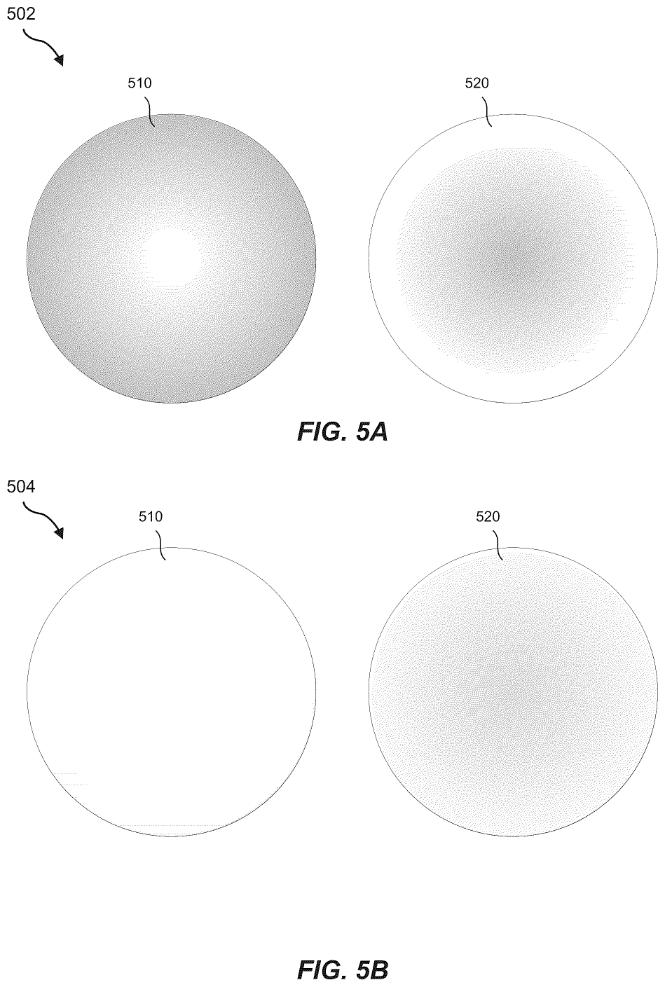

FIGS. 5A and 5B illustrate a pair of optical elements transitioning with complementary non-uniform transmissivity. As shown in FIG. 5A, in a state 502, a varifocal lens 510 may exhibit a radially decreasing transmissivity. In response, apparatuses and systems described herein may regulate a transmissivity of a component 520 (such as, e.g., a PBP lens) to complement the transmissivity of varifocal lens 510 (e.g., by providing a radially increasing transmissivity). In one example, control circuitry that regulates the optical power (and, therefore, indirectly regulates the transmissivity) of varifocal lens 510 may transmit a control signal to component 520 to regulate the transmissivity of component 520 to be complementary to that of varifocal lens 510 (e.g., both in terms of overall transmissivity and in distribution of transmissivity) such that varifocal lens 510 and component 520 in tandem provide, combined, a substantially uniform and predetermined target level of transmissivity.

As shown in FIG. 5B, in a state 504, a varifocal lens 510 may exhibit a radially decreasing transmissivity to a lesser degree than in state 502. In response, apparatuses and systems described herein may regulate a transmissivity of a component 520 to complement the transmissivity of varifocal lens 510 (e.g., by providing a transmissivity that radially increases to a lesser degree). In one example, control circuitry that regulates the optical power (and, therefore, indirectly regulates the transmissivity) of varifocal lens 510 may transmit a control signal to component 520 to regulate the transmissivity of component 520 to be complementary to that of varifocal lens 510 (e.g., both in terms of overall transmissivity and in distribution of transmissivity) such that varifocal lens 510 and component 520 in tandem provide, combined, a substantially uniform and predetermined target level of transmissivity.

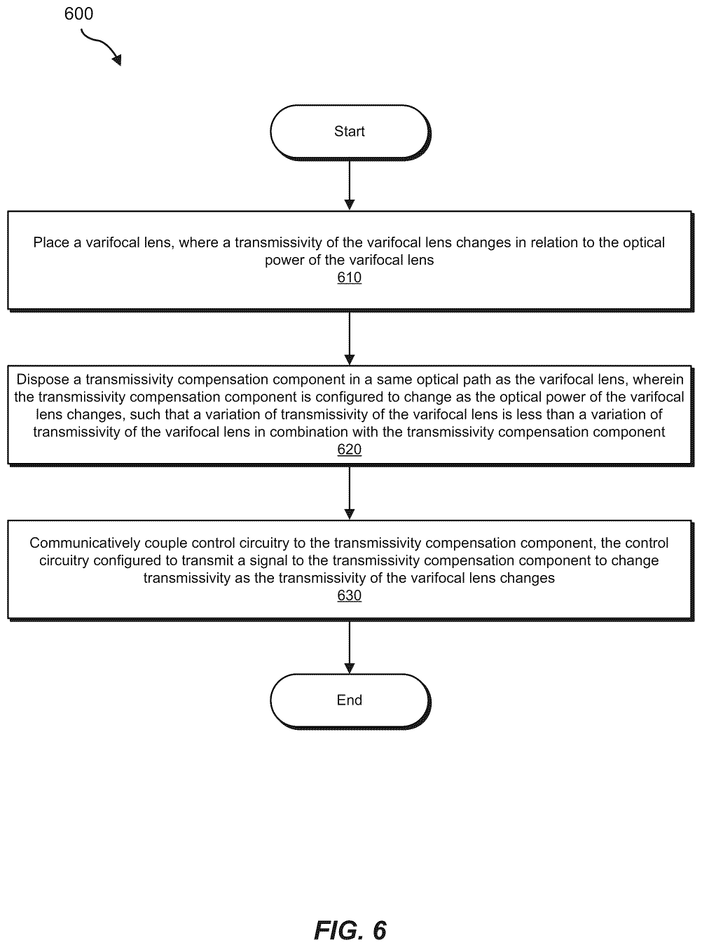

FIG. 6 illustrates a method of manufacture 600 for Pancharatnam-Berry phase augmented gradient-index liquid crystal lenses. As shown in FIG. 6, at step 602 method 600 may include placing a varifocal lens, where the transmissivity of the varifocal lens changes in relation to the optical power of the varifocal lens. For example, step 602 may include placing a GRIN LC lens.

At step 604, method 600 may include disposing a transmissivity compensation component in a same optical path as the varifocal lens, where the transmissivity compensation component is configured to change as the optical power of the varifocal lens changes, such that a variation of transmissivity of the varifocal lens is less than a variation of transmissivity of the varifocal lens in combination with the transmissivity compensation component. For example, step 604 may include coupling a surface of a PBP lens to a surface of the GRIN LC lens.

At step 606, method 600 may also include communicatively coupling control circuitry to the transmissivity compensation component, the control circuitry being configured to transmit a signal to the transmissivity compensation component to change transmissivity as the transmissivity of the varifocal lens changes. For example, step 606 may include communicatively coupling both the GRIN LC lens and the PBP lens to a control module that regulates the optical power of the GRIN LC lens and the transmissivity of the PBP lens. Additionally or alternatively, step 606 may include communicatively coupling a control module that reads a signal that regulates the optical power of the GRIN LC lens and generating a signal that regulates the PBP lens to produce a complementary level of transmissivity.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 400 in FIG. 4) or that visually immerses a user in an artificial reality (such as, e.g., virtual-reality system 500 in FIG. 5). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 4, augmented-reality system 400 may include an eyewear device 402 with a frame 410 configured to hold a left display device 415(A) and a right display device 415(B) in front of a user's eyes. Display devices 415(A) and 415(B) may act together or independently to present an image or series of images to a user. While augmented-reality system 400 includes two displays, embodiments of this disclosure may be implemented in augmented-reality systems with a single NED or more than two NEDs.

In some embodiments, augmented-reality system 400 may include one or more sensors, such as sensor 440. Sensor 440 may generate measurement signals in response to motion of augmented-reality system 400 and may be located on substantially any portion of frame 410. Sensor 440 may represent one or more of a variety of different sensing mechanisms, such as a position sensor, an inertial measurement unit (IMU), a depth camera assembly, a structured light emitter and/or detector, or any combination thereof. In some embodiments, augmented-reality system 400 may or may not include sensor 440 or may include more than one sensor. In embodiments in which sensor 440 includes an IMU, the IMU may generate calibration data based on measurement signals from sensor 440. Examples of sensor 440 may include, without limitation, accelerometers, gyroscopes, magnetometers, other suitable types of sensors that detect motion, sensors used for error correction of the IMU, or some combination thereof.

In some examples, augmented-reality system 400 may also include a microphone array with a plurality of acoustic transducers 420(A)-420(J), referred to collectively as acoustic transducers 420. Acoustic transducers 420 may represent transducers that detect air pressure variations induced by sound waves. Each acoustic transducer 420 may be configured to detect sound and convert the detected sound into an electronic format (e.g., an analog or digital format). The microphone array in FIG. 4 may include, for example, ten acoustic transducers: 420(A) and 420(B), which may be designed to be placed inside a corresponding ear of the user, acoustic transducers 420(C), 420(D), 420(E), 420(F), 420(G), and 420(H), which may be positioned at various locations on frame 410, and/or acoustic transducers 420(l) and 420(J), which may be positioned on a corresponding neckband 405.

In some embodiments, one or more of acoustic transducers 420(A)-(J) may be used as output transducers (e.g., speakers). For example, acoustic transducers 420(A) and/or 420(B) may be earbuds or any other suitable type of headphone or speaker.

The configuration of acoustic transducers 420 of the microphone array may vary. While augmented-reality system 400 is shown in FIG. 4 as having ten acoustic transducers 420, the number of acoustic transducers 420 may be greater or less than ten. In some embodiments, using higher numbers of acoustic transducers 420 may increase the amount of audio information collected and/or the sensitivity and accuracy of the audio information. In contrast, using a lower number of acoustic transducers 420 may decrease the computing power required by an associated controller 450 to process the collected audio information. In addition, the position of each acoustic transducer 420 of the microphone array may vary. For example, the position of an acoustic transducer 420 may include a defined position on the user, a defined coordinate on frame 410, an orientation associated with each acoustic transducer 420, or some combination thereof.

Acoustic transducers 420(A) and 420(B) may be positioned on different parts of the user's ear, such as behind the pinna, behind the tragus, and/or within the auricle or fossa. Or, there may be additional acoustic transducers 420 on or surrounding the ear in addition to acoustic transducers 420 inside the ear canal. Having an acoustic transducer 420 positioned next to an ear canal of a user may enable the microphone array to collect information on how sounds arrive at the ear canal. By positioning at least two of acoustic transducers 420 on either side of a user's head (e.g., as binaural microphones), augmented-reality device 400 may simulate binaural hearing and capture a 3D stereo sound field around about a user's head. In some embodiments, acoustic transducers 420(A) and 420(B) may be connected to augmented-reality system 400 via a wired connection 430, and in other embodiments acoustic transducers 420(A) and 420(B) may be connected to augmented reality system 400 via a wireless connection (e.g., a BLUETOOTH connection). In still other embodiments, acoustic transducers 420(A) and 420(B) may not be used at all in conjunction with augmented-reality system 400.

Acoustic transducers 420 on frame 410 may be positioned in a variety of different ways, including along the length of the temples, across the bridge, above or below display devices 415(A) and 415(B), or some combination thereof. Acoustic transducers 420 may also be oriented such that the microphone array is able to detect sounds in a wide range of directions surrounding the user wearing the augmented-reality system 400. In some embodiments, an optimization process may be performed during manufacturing of augmented-reality system 400 to determine relative positioning of each acoustic transducer 420 in the microphone array.

In some examples, augmented-reality system 400 may include or be connected to an external device (e.g., a paired device), such as neckband 405. Neckband 405 generally represents any type or form of paired device. Thus, the following discussion of neckband 405 may also apply to various other paired devices, such as charging cases, smart watches, smart phones, wrist bands, other wearable devices, hand-held controllers, tablet computers, laptop computers, other external compute devices, etc.

As shown, neckband 405 may be coupled to eyewear device 402 via one or more connectors. The connectors may be wired or wireless and may include electrical and/or non-electrical (e.g., structural) components. In some cases, eyewear device 402 and neckband 405 may operate independently without any wired or wireless connection between them. While FIG. 4 illustrates the components of eyewear device 402 and neckband 405 in example locations on eyewear device 402 and neckband 405, the components may be located elsewhere and/or distributed differently on eyewear device 402 and/or neckband 405. In some embodiments, the components of eyewear device 402 and neckband 405 may be located on one or more additional peripheral devices paired with eyewear device 402, neckband 405, or some combination thereof.

Pairing external devices, such as neckband 405, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 400 may be provided by a paired device or shared between a paired device and an eyewear device, thus reducing the weight, heat profile, and form factor of the eyewear device overall while still retaining desired functionality. For example, neckband 405 may allow components that would otherwise be included on an eyewear device to be included in neckband 405 since users may tolerate a heavier weight load on their shoulders than they would tolerate on their heads. Neckband 405 may also have a larger surface area over which to diffuse and disperse heat to the ambient environment. Thus, neckband 405 may allow for greater battery and computation capacity than might otherwise have been possible on a stand-alone eyewear device. Since weight carried in neckband 405 may be less invasive to a user than weight carried in eyewear device 402, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 405 may be communicatively coupled with eyewear device 402 and/or to other devices. These other devices may provide certain functions (e.g., tracking, localizing, depth mapping, processing, storage, etc.) to augmented-reality system 400. In the embodiment of FIG. 4, neckband 405 may include two acoustic transducers (e.g., 420(l) and 420(J)) that are part of the microphone array (or potentially form their own microphone subarray). Neckband 405 may also include a controller 425 and a power source 435.

Acoustic transducers 420(l) and 420(J) of neckband 405 may be configured to detect sound and convert the detected sound into an electronic format (analog or digital). In the embodiment of FIG. 4, acoustic transducers 420(l) and 420(J) may be positioned on neckband 405, thereby increasing the distance between the neckband acoustic transducers 420(l) and 420(J) and other acoustic transducers 420 positioned on eyewear device 402. In some cases, increasing the distance between acoustic transducers 420 of the microphone array may improve the accuracy of beamforming performed via the microphone array. For example, if a sound is detected by acoustic transducers 420(C) and 420(D) and the distance between acoustic transducers 420(C) and 420(D) is greater than, e.g., the distance between acoustic transducers 420(D) and 420(E), the determined source location of the detected sound may be more accurate than if the sound had been detected by acoustic transducers 420(D) and 420(E).

Controller 425 of neckband 405 may process information generated by the sensors on neckband 405 and/or augmented-reality system 400. For example, controller 425 may process information from the microphone array that describes sounds detected by the microphone array. For each detected sound, controller 425 may perform a direction-of-arrival (DOA) estimation to estimate a direction from which the detected sound arrived at the microphone array. As the microphone array detects sounds, controller 425 may populate an audio data set with the information. In embodiments in which augmented-reality system 400 includes an inertial measurement unit, controller 425 may compute all inertial and spatial calculations from the IMU located on eyewear device 402. A connector may convey information between augmented-reality system 400 and neckband 405 and between augmented-reality system 400 and controller 425. The information may be in the form of optical data, electrical data, wireless data, or any other transmittable data form. Moving the processing of information generated by augmented-reality system 400 to neckband 405 may reduce weight and heat in eyewear device 402, making it more comfortable to the user.

Power source 435 in neckband 405 may provide power to eyewear device 402 and/or to neckband 405. Power source 435 may include, without limitation, lithium ion batteries, lithium-polymer batteries, primary lithium batteries, alkaline batteries, or any other form of power storage. In some cases, power source 435 may be a wired power source. Including power source 435 on neckband 405 instead of on eyewear device 402 may help better distribute the weight and heat generated by power source 435.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 500 in FIG. 5, that mostly or completely covers a user's field of view. Virtual-reality system 500 may include a front rigid body 502 and a band 504 shaped to fit around a user's head. Virtual-reality system 500 may also include output audio transducers 506(A) and 506(B). Furthermore, while not shown in FIG. 5, front rigid body 502 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 400 and/or virtual-reality system 500 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 400 and/or virtual-reality system 500 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 400 and/or virtual-reality system 500 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An apparatus comprising:
a varifocal lens, wherein the transmissivity of the varifocal lens changes in relation to the optical power of the varifocal lens; and
a transmissivity compensation component that is configured to change as the optical power of the varifocal lens changes, such that a variation of transmissivity of the varifocal lens is less than a variation of transmissivity of the varifocal lens in combination with the transmissivity compensation component.

2. The apparatus of claim 1, wherein:
the varifocal lens is planar; and
the transmissivity compensation component is planar.

3. The apparatus of claim 1, wherein the varifocal lens comprises a gradient-index liquid crystal lens.

4. The apparatus of claim 3, wherein the transmissivity compensation component comprises a Pancharatnam-Berry phase element.

5. The apparatus of claim 1, further comprising control circuitry that transmits a signal to the transmissivity compensation component that regulates a transmissivity of the transmissivity compensation component.

6. The apparatus of claim 5, wherein the control circuitry generates the signal based at least in part on at least one of:
a signal received by the control circuitry to change an optical power of the varifocal lens;
a signal received by the control circuitry indicating a change to the optical power of the varifocal lens; or
a signal received by the control circuitry indicating a change to a transmissivity of the varifocal lens.

7. The apparatus of claim 1, wherein a change in the transmissivity of the varifocal lens in relation to the optical power of the varifocal lens is non-uniform across the varifocal lens.

8. The apparatus of claim 7, wherein the transmissivity compensation component is configured to change as the optical power of the varifocal lens changes such that a non-uniformity of transmissivity of the varifocal lens is less than a non-uniformity of transmissivity of the varifocal lens in combination with the transmissivity compensation component.

9. The apparatus of claim 7, wherein a change in the transmissivity of the varifocal lens in relation to the optical power of the varifocal lens varies radially across the varifocal lens.

10. The apparatus of claim 9, wherein the transmissivity compensation component is configured to change with a radial distribution across the transmissivity compensation component as the optical power of the varifocal lens changes.

11. A system comprising:
a lens apparatus, comprising:
a varifocal lens, wherein the transmissivity of the varifocal lens changes in relation to the optical power of the varifocal lens; and
a transmissivity compensation component that is configured to change as the optical power of the varifocal lens changes, such that a variation of transmissivity of the varifocal lens is less than a variation of transmissivity of the varifocal lens in combination with the transmissivity compensation component;
an accommodation module; and
a head-mounted display.

12. The system of claim 11, wherein the head-mounted display comprises a virtual image display.

13. The system of claim 12, wherein:
the accommodation module is on an eye side of the display; and
the varifocal lens and the transmissivity compensation component are on the world side of the display.

14. The system of claim 11, wherein the varifocal lens comprises a gradient-index liquid crystal lens.

15. The system of claim 11, wherein the transmissivity compensation component comprises a Pancharatnam-Berry phase element.

16. The system of claim 11, further comprising control circuitry that transmits a signal to the transmissivity compensation component that regulates a transmissivity of the transmissivity compensation component.

17. The system of claim 16, wherein the control circuitry generates the signal based at least in part on at least one of:
a signal received by the control circuitry to change an optical power of the varifocal lens;
a signal received by the control circuitry indicating a change to the optical power of the varifocal lens; or
a signal received by the control circuitry indicating a change to a transmissivity of the varifocal lens.

18. The system of claim 11, wherein a change in a transmissivity of the varifocal lens in relation to the optical power of the varifocal lens is non-uniform across the varifocal lens.

19. The system of claim 11, wherein the transmissivity compensation component is configured to change as the optical power of the varifocal lens changes such that a non-uniformity of transmissivity of the varifocal lens is less than a non-uniformity of transmissivity of the varifocal lens in combination with the transmissivity compensation component.

20. A method of manufacture, comprising:
placing a varifocal lens, wherein a transmissivity of the varifocal lens changes in relation to the optical power of the varifocal lens;
disposing a transmissivity compensation component in a same optical path as the varifocal lens, wherein the transmissivity compensation component is configured to change as the optical power of the varifocal lens changes, such that a variation of transmissivity of the varifocal lens is less than a variation of transmissivity of the varifocal lens in combination with the transmissivity compensation component; and
communicatively coupling control circuitry to the transmissivity compensation component, the control circuitry configured to transmit a signal to the transmissivity compensation component to change transmissivity as the transmissivity of the varifocal lens changes.
